(19) United States
(12) Patent Application Publication
(10) Pub. No.: US 2007/0193080 A1
(43) Pub. Date: Aug. 23, 2007

(54) Display article

(76) Inventor: Benjamin Hillman, Brighton (GB)

Correspondence Address: King & Partners, PLC, 170 College Avenue, SUITE 230, HOLLAND, MI, 49423, US

(21) Appl. No.: 11/359,758

(22) Filed: Feb. 22, 2006

(51) Int. Cl. G09F 1/00

(52) U.S. Cl. 40/124.08

(57) ABSTRACT

The present invention relates to a display article (1) comprising a first member (3) and a second member (5) movable relative to each other between an open position and a closed position. A section (20, 22, 24) of the first member (3) is displaceable away from an adjacent area thereof to enable said section (20, 22, 24) to be silhouetted by light emitted from a device for emitting light (37). The present invention also relates to a blank (31) for forming the display article (1).

The present application relates to a display article. More particularly, the present application relates to an illuminated greetings card, menu or promotional item.

Greetings cards are purchased worldwide for numerous occasions, yet when on display are only really effective in well-lit environments and enjoyed at close proximity. Designs often lack impact in dimmed light and thus cannot be enjoyed to the full.

It is known to provide illuminated greetings cards.

DE 20214732 discloses a greetings card having a cut-out covered by a transparent screen. A light source is sandwiched between an inside flap and a back flap of the greetings card to illuminate the cut-out when the greetings card is opened.

A similar arrangement is disclosed in US 2004/0205988. A light emitting element is provided inside a housing forming the back of a greetings card. A light permeable foil is provided over an opening in the housing and a picture or image may be formed on the foil by imprinting with a light impermeable colouring agent. The image is displayed by light passing through the portions of the foil not imprinted with an impermeable colouring agent.

A greetings card incorporating an electroluminescent is disclosed in US 2003/0192209. The electroluminescent lamp provides uniform lighting over its surface and may be used to form part of a pop-up display inside the card.

The inventor has recognised certain limitations with known illuminated greetings cards which may narrow their appeal. For example, usually only a relatively small portion of the greetings card is illuminated and the visual impact of the card may therefore be limited. Moreover, the illuminated portion of the card is typically provided on the inside of the card and is generally only visible when the card is opened.

Viewed from a first aspect, the present application relates to a display article comprising a first member, a second member and at least one device for emitting light, the first and second members being movable relative to each other between an open position and a closed position; wherein a section of the first member is displaceable away from an adjacent area of the first member to enable said section to be silhouetted by light emitted from said at least one device.

As least in preferred embodiments, the creation of a silhouetted image is visually striking and the display article can be enjoyed at any time of day or night. The display article may also be used as an ambient light source enabling it to live beyond fulfilling its primary function. The shadows cast by the display article may also add to its visual appeal.

The first member preferably forms the front of the display article when it is erected. The second member preferably forms the back of the display article when it is erected.

The first member is preferably substantially planar and the section is preferably displaceable out of said plane.

The section may be displaceable in a rearwards direction, towards the second member. Preferably, however, the section is displaceable in a forwards direction, away from the second member. The displacement of the section of the first member creates an aperture which is illuminated by the at least one device. The section of the first member is preferably displaceable away from the adjacent area of the first member by bending or folding. The section is preferably integrally formed with said first member.

The at least one device for emitting light is preferably provided between said first and second members. The at least one device may be mounted on the first member. Preferably, however, the at least one device is mounted on the second member. The location of the at least one device may be varied depending on the location of the displaceable section of the first member.

The displaceable section of the first member is preferably shaped to form part or all of a letter, symbol, word or phrase. The section may alternatively form part or all of an image. The display article may comprise a plurality of displaceable sections which form a combination of letters, words, phrases and/or images. It will be appreciated that different display articles may be created by varying the design of the displaceable section(s).

The section of the first member may be displaced manually. Preferably, however, the section is displaced from said adjacent area of the first member when the first and second members are moved to said open position. For example, if the display article is a greetings card, the section may be displaced away from the remainder of the first member when the greetings card is opened.

A plurality of sections may be provided.

The display article preferably also includes an opening or a contoured edge for defining at least part of a shape, such as a symbol, letter, word or image.

Viewed from a further aspect, the present application relates to a display article comprising a first member, a second member and at least one device for emitting light, the first and second members being movable relative to each other between an open position and a closed position, the first member having a contoured edge for defining at least part of a shape; wherein said at least one device is provided between said first and second members and is operable to backlight the first member.

In use, the at least part of a shape is illuminated by the at least one device.

The contoured edge may be defined by an aperture provided in said first member. The shape may be a symbol, letter, word or image. Alternatively, the contoured edge may be defined by an outside edge of the first member. In this arrangement, the at least part of a shape is silhouetted by the at least one device.

It will, of course, be appreciated that the display article may include more than one contoured edge defined by an aperture and/or an outside edge.

A section of the first member may be displaceable away from an adjacent area of the first member to enable said section to be silhouetted by light emitted from said at least one device.

The displacement of the section of the first member creates an aperture which is illuminated by the at least one device. The section of the first member is preferably displaceable away from the adjacent area of the first member by bending or folding. The section is preferably integrally formed with said first member.

The section may be shaped to form part or all of a letter, symbol, word or phrase. Alternatively, the section may be shaped to form part or all of an image. Again, the display article may comprise a plurality of displaceable sections which form a combination of letters, words, phrases and/or images.

The section is preferably displaced from said adjacent area of the first member when the first and second members are moved to said open position.

The first and second members are preferable sheet members. The first and second members are preferably formed from a sheet material. Most preferably, the first and second members are formed from a single sheet of said sheet material. The sheet material may be pulp-based, such as paper, card or board. Alternatively, the sheet material may be made of a plastics material, for example polypropylene.

The first and second members are preferably joined along a common edge. The members are preferably moveable relative to each other by folding them about this common edge.

The first and second members preferably form an A-shape. The vertex may be arranged horizontally or vertically when the display article is in use.

The display article preferably comprises a third member for limiting displacement of the first member relative to the second member. This may help reduce the problem of splaying, whereby a display article, such as a greetings card, loses structural integrity and falls flat. The third member preferably forms a base on which the display article rests.

One, two, three or more sides of the display article are preferably open. This arrangement allows light from the display article to escape through the sides thereof. This may increase the visual impact of the display article. The display article may be used for other purposes, such as a nightlight or other ambient light source.

A switch is preferably provided for operating the at least one device for emitting light. The switch may be operable manually, for example incorporating a simple ON/OFF switch which may readily be used by people of most ages. The ON/OFF switch may be incorporated into any feature of the display article.

Alternatively, the at least one device may be operable automatically. The switch may, for example, operate when said first and second members are moved to their open position. Alternatively, a light sensor may be provided automatically to operate the at least one device when the ambient light drops below a predetermined level.

The display article preferably includes a battery. The battery is preferably replaceable or rechargeable to allow the life of the display article to be increased.

The first and second members are preferably folded against each other when the article is in said closed position. This may advantageously allow the display article to be folded for storage or to be inserted into an envelope for posting.

The display article may comprise a plurality of devices for emitting light. The devices may be in a range of different colours further to enhance the appeal thereof. The at least one device is preferably an LED or a bulb, but other light sources, such as an electroluminescent material may be used. The at least one device for emitting light is preferably mounted on the second member.

An image or indicia may be printed onto the first member of the display article. The at least one device for emitting light may highlight or compliment a particular feature or features of the printed design. A message or greeting may also be provided on the display article.

Viewed from a still further aspect, the present application relates to a display article comprising a sheet member and at least one device for emitting light; wherein a section of the sheet member is displaceable away from an adjacent area thereof to form an aperture for allowing light from said element to pass through the first member.

The displaceable section of the sheet member is preferably in the shape of part or all of a letter, symbol, word or image.

The display article may be three-dimensional, for example in the form of a cylinder or a cube. The display article may, for example, form a three-dimensional greetings card. The display article is preferably collapsible.

Viewed from a yet still further aspect the present application relates to a collapsible display article comprising a sheet member with at least one aperture provided therein for forming at least part of a shape; the collapsible display article further comprising at least one light emitting device for backlighting said sheet member.

The display article may be used as a promotional item or a branding item. Equally, the display article may be for use in a bar or restaurant, for example to function as a combined table light and menu. The at least one device for emitting light may advantageously be arranged to illuminate a particular area of the display article, such as a name of a restaurant, hotel or business.

The shape displayed may be a symbol, character, word or image. For example, the shape may display a brand name or company logo.

The display article is preferably a card, such as a greetings card or a decorative card. The display article may equally be a card for an invitation to a party, wedding or other social function. The invention may be applied to a range of greetings card shapes, styles and sizes.

The card may be three-dimensional, for example a cylinder or a cube. The card is preferably collapsible.

Viewed from a yet further aspect, the present application relates to a card comprising a front sheet member and a back sheet member, the front and back sheet members being movable relative to each other between an open position and a closed position, the front sheet member having at least one contoured edge for defining at least part of a shape; the card further comprising at least one light emitting device for backlighting said front sheet member. The card is preferably a greetings card. The at least one light emitting device is preferably mounted on said back sheet member

Viewed from a still further aspect, the present application relates to a card comprising a front sheet member and a back sheet member, the front and back sheet members being movable relative to each other between an open position and a closed position, a section of the front sheet member being displaceable away from an adjacent area of the front sheet member; the card further comprising at least one light emitting device for illuminating said section of the front sheet member.

The present application also relates to a blank for forming a display article or card as described herein.

Viewed from a further aspect, the present application relates to a greetings card whereby the design on the decorative and viewable surface(s) is/are backlit, producing an ambient light source. The light source may be an LED or other appropriate light source operable with a switch mechanism. The greetings card may be manufactured with different coloured LEDs/bulbs.

At least in preferred embodiments, a greetings card is provided that can be enjoyed at any time, day or night, acting as an ambient light source, thus allowing the card to live beyond its primary function.

The electronic components may be manufactured as a sealed unit, emitting said light source.

The light source is preferably contained within the interior surfaces of the card.

The backlighting function can be incorporated into a range of card formats including three-dimensional structures.

The greetings card has one or more LEDS/bulbs which are operable using an ON/OFF switch. The switch may be push-button, sliding or the like.

The greetings card preferably has an ‘A’ frame structure that, at least in preferred embodiments, prevents the card from slipping, collapsing and/or loosing structural integrity.

The viewable and/or decorative surfaces of the greetings card preferably comprise printed, cut-out/silhouetted, embossed designs. The greetings card preferably has sections that lift forward and stand proud of the face of the card.

The greetings card can be manufactured from a variety of materials, including card and polypropylene. The greetings card can incorporate other materials, such as photographic colour gels, to diffuse the window of light.

The preferred features described in respect of a greetings card may equally be applied to display articles.

Preferred embodiments of the present invention will now be described by way of example only and with reference to the accompanying drawings, in which:

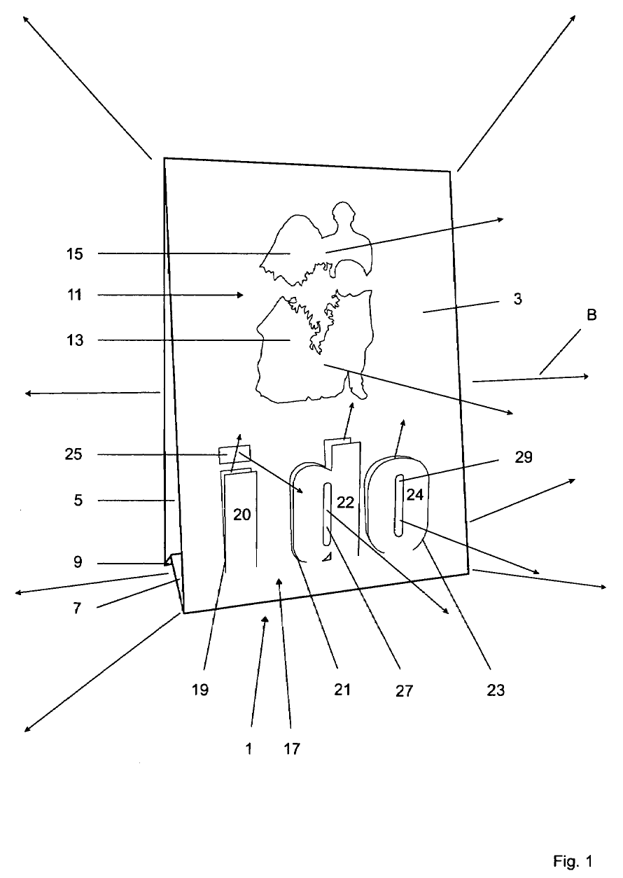

FIG. 1 shows a perspective view of a greetings card in accordance with a first embodiment of the present invention;

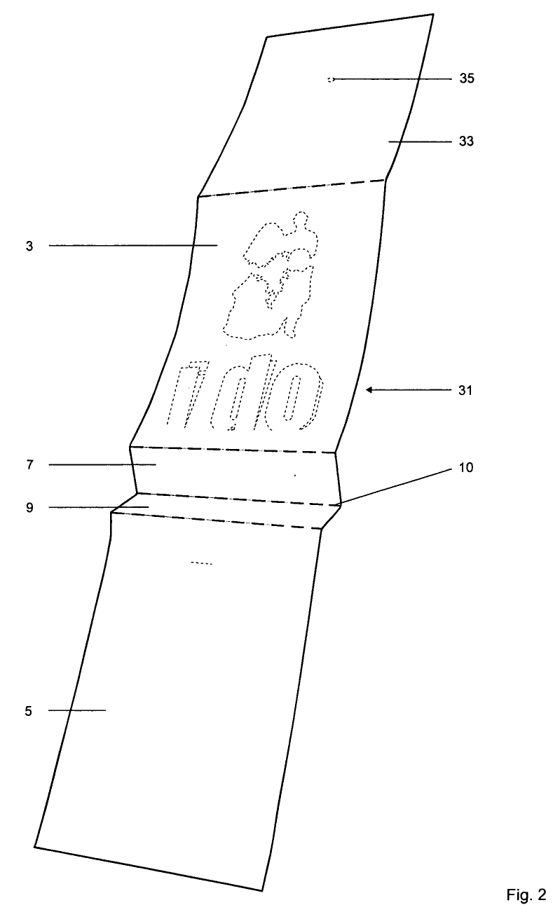

FIG. 2 shows a perspective view of the blank for forming the greetings card shown in FIG. 1;

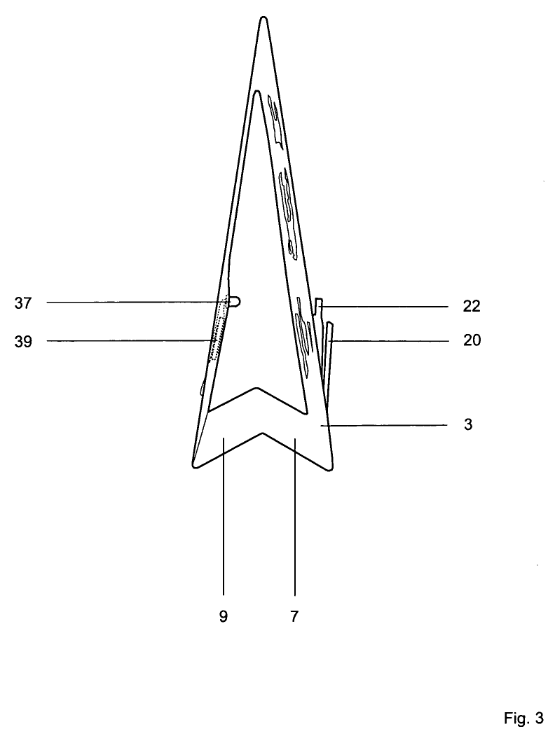

FIG. 3 shows a side view of the erected greetings card according to the first embodiment of the present invention;

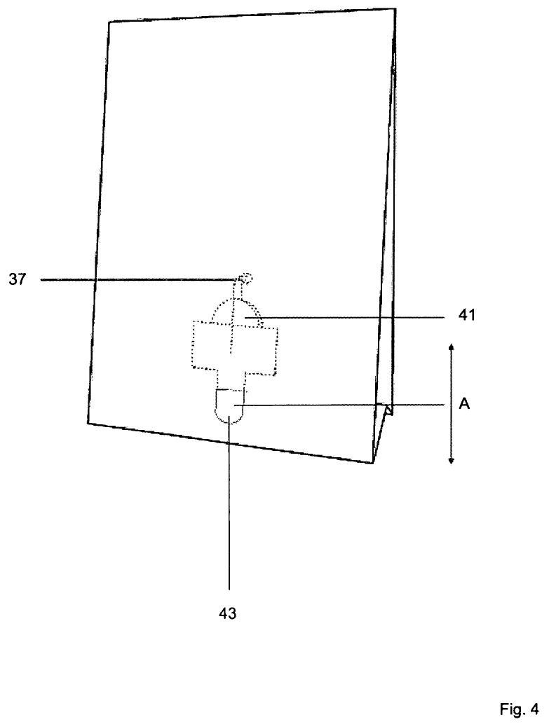

FIG. 4 shows a rear view of the erected greetings card according to the first embodiment of the present invention;

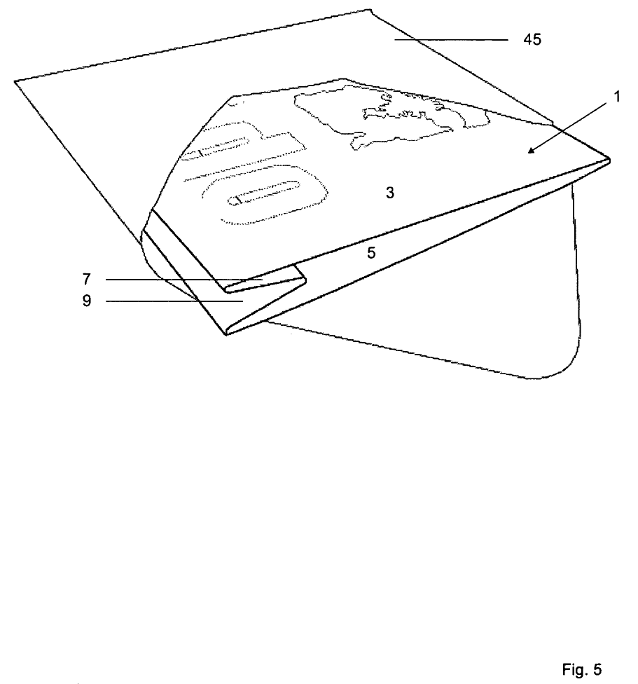

FIG. 5 shows a perspective view of the greetings card according to the first embodiment of the present invention in a collapsed form located in an envelope; and

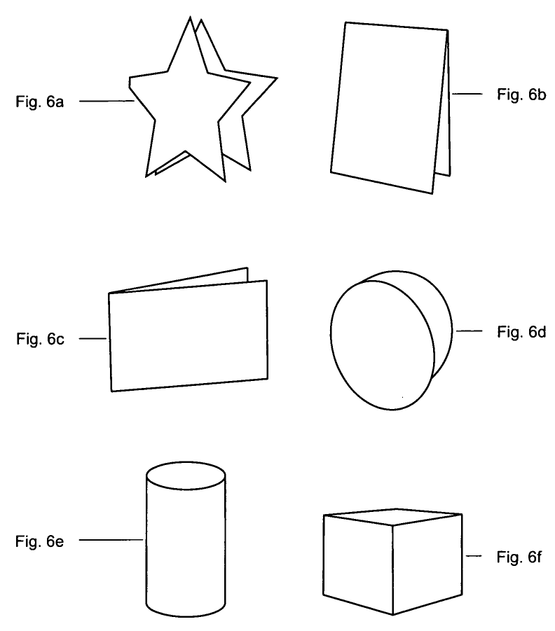

FIGS. 6a to 6f show alternative embodiments of greetings cards in accordance with the present invention.

A greetings card 1 in accordance with a first embodiment of the present invention is shown in FIG. 1. The card 1 comprises a front sheet member 3, a back sheet member 5, a first base panel 7, and a second base panel 9. A fold line 10 is provided between the first and second base panels 7, 9. A greeting may be printed on the back of the back sheet member 5 and a personal message written.

The greetings card 1 has an image 11 provided in the front sheet member 3. The image 11 in the present case is made up of a first aperture 13 and a second aperture 15. The edges of the first and second apertures 13, 15 are contoured to represent a bride and groom in the present case. It will be appreciated that alternative images may be provided, depending on the theme of the card.

A phrase 17 is also formed in the card 1 by a series of slits cut in the front sheet member 3. In the present case, the phrase 17 is “I do” and three slits 19, 21, 23 are provided, each slit defining a section 20, 22, 24 of the front sheet member 3 corresponding to part of all of each letter in the phrase. The slits 19, 21, 23 each extend only partway around the outside of the respective letters such that the sections 20, 22, 24 making up the letters are not separated from the front sheet 3. Openings 25, 27, 29 are provided to highlight specific features of each of the letters so that they may more readily be identified.

The greetings card 1 is formed from a single blank 31 of sheet material, as shown in FIG. 2. The first and second apertures 13, 15; the slits 19, 21, 23; and the openings 25, 27, 29 are preferably cut in the blank 31 simultaneously. The fold lines between the first and second base panels and the front and back sheets may also be stamped into the blank 31 to assist assembly of the card 1.

As shown in FIG. 2, an inner sheet member 33 is provided which overlaps with the back sheet member 5 when the card 1 is assembled. The inner sheet member 33 and the back sheet member 5 are bonded together to assemble the card 1.

A hole 35 is provided in the inner sheet member 33 for mounting an LED 37. The positioning of the LED is dependent on the design 13 and/or phrase 17 on the card 1. The hole 35 allows for the secure and correct positioning of the LED 37. As shown in FIG. 3, the LED 37 projects through the hole 35 into the space provided between the front and back sheet members 3, 5 when the card 1 is erected. The LED 37 faces the back of the front sheet member 3 to allow the design 11 and phrase 17 to be backlit. A control circuit 39 and a battery 41, as shown in phantom in FIG. 4, are sandwiched between the back sheet member 5 and the inner sheet member 33 to retain them in position.

An ON/OFF switch 43 extends through a slot 44 in the back sheet member 5. The switch 43 is operated manually by moving it up and down, as represented by arrow A in FIG. 4. In this particular embodiment, the switch 43 is slid upwards to turn the LED 37 off; and is slid downwards to turn the LED on. The shape and location of the slot may be varied depending on the particular type of switch 43 used. A rotary, push-button or toggle switch may also be used.

The first and second base panels 7, 9 may be folded between the front and back sheet members 3, 5 to collapse the card 1, as shown in FIG. 5. The fold line 10 between the first and second base panels 7, 9 allows the card 1 to be folded flat. The sections 20, 22, 24 are folded flat into the plane of the front sheet member 3. The collapsed card 1 may be inserted into an envelope 45 for posting.

The card 1 is erected by displacing the front and back sheet members 3, 5 away from each other. The resilience of the sheet material making up the card 1 advantageously may cause the first and second base panels 7, 9 to bias the front and back sheet members 3, 5 away from each other towards this erected position. The first and second base panels 7, 9 help to define the particular ‘A’ frame design, and help eliminate the possibility of the card collapsing.

The sections 20, 22, 24 of the front sheet 3 making up the letters in the phrase 17 are displaced from the adjacent area of the front sheet when the card 1 is erected, as shown in FIG. 1. The sections 20, 22, 24 may be displaced when the card 1 is erected or a user may pull them forward to create the raised design. The displacement of the sections 20, 22, 24 away from the adjacent area of the front sheet 3 creates openings in the front sheet member 3 through which light from the LED 37 may pass. The displacement of the sections 20, 22, 24 forwards out of the plane of the front sheet member 3 helps add greater dimension to the design.

The LED 37 is switched on using the switch 43 and the front sheet member 3 is backlit. Light passes through the first and second apertures 13, 15 and illuminates the image 11. A silhouette effect is created by the first and second apertures 13, 15. Light also passes through the openings created by the displacement of the sections 20, 22, 24 such that the letters in the phrase 17 are displayed in silhouette. Light also escapes through the sides of the card 1 to create additional lighting. The dispersion of light from the LED 37 is illustrated by arrows B in FIG. 1.

The LED 37 may be turned off when desired using the switch 43.

It will be appreciated that the card 1 could also include a loudspeaker and control electronics for playing a tune. The loudspeaker and control electronics could also be operated by the switch 43.

One or more apertures may also be created in the back sheet member of the card 1 to create additional effects. These may, for example, indicate the name of the card manufacturer or supplier.

The backlighting feature and the ambient light source it creates is applicable to varying styles of cards. Alternative embodiments of cards in accordance with the present invention are shown in FIGS. 6a to 6f. These cards correspond generally to the first embodiment of the present invention but have different configurations. Apertures have been omitted from these Figures for clarity.

The cards in FIGS. 6a to 6d are respectively star-shaped; rectangular portrait; rectangular landscape; and substantially circular in shape.

The cards in FIGS. 6e and 6f have collapsible three-dimensional shapes. In particular, the card illustrated in FIG. 6e is cylindrical; and the card illustrated in FIG. 6F is a cube. Three-dimensional shapes may be desirable for other display articles, such as menus, in accordance with the present invention.

A bulb, LED or other light source may be provided in the card. Moreover, more than one light source may be provided for a particular design. The location and/or colour of the light sources may be varied for different designs.

The aperture(s) making up the image in a card may be covered with a transparent sheet material. This material may be coloured to create additional lighting effects.

1. A display article comprising a first member, a second member and at least one device for emitting light, the first and second members being movable relative to each other between an open position and a closed position; wherein a section of the first member is displaceable away from an adjacent area of the first member to enable said section to be silhouetted by light emitted from said at least one device.

2. The display article as claimed in claim 1, wherein the section is displaceable away from the adjacent area of the first member by bending or folding.

3. The display article as claimed in claim 1, wherein the section is integrally formed with said first member.

4. The display article as claimed in claim 1, wherein said at least one device for emitting light is provided between said first and second members

5. The display article as claimed in claim 1, wherein said section of the first member is shaped to form part or all of a letter, symbol, word, phrase, or image.

6. (canceled)

7. The display article as claimed in claim 1, wherein said section is displaced from said adjacent area of the first member when the first and second members are moved to said open position.

8. The display article as claimed in claim 1, wherein the first member further comprises an opening for defining at least part of a shape, such as a symbol, letter, word or image.

9. The display article as claimed in claim 1, wherein the first member has a contoured edge for defining at least part of a shape, such as a symbol, letter, word or image.

10. The display article as claimed in claim 1, wherein said first and second members are formed from a sheet material.

11. The display article as claimed in claim 1, wherein said first and second members are hinged together along a common edge.

12. The display article as claimed in claim 11, wherein at least one side of the display article away from said common edge is open.

13. The display article as claimed in claim 1, further comprising a switch for operating said at least one device for emitting light.

14. The display article as claimed in claim 1, further comprising a third member for limiting displacement of the first member relative to the second member.

15. The display article as claimed in claim 1, wherein the first and second members are folded against each other when the article is in said closed position.

16. The display article as claimed in claim 1, wherein said display article is a decorative card, greetings card, menu, or a promotional item.

17. A display article comprising a first member, a second member and at least one device for emitting light, the first and second members being movable relative to each other between an open position and a closed position, the first member having a contoured edge for defining at least part of a shape; wherein said at least one device is provided between said first and second members and is operable to backlight the first member.

18. The display article as claimed in claim 17, wherein said contoured edge is defined by an aperture provided in said first member.

19. The display article as claimed in claim 17, wherein said contoured edge is defined by an outside edge of the first member.

20. The display article as claimed in claim 17, wherein a section of the first member is displaceable away from an adjacent area of the first member to enable said section to be silhouetted by light emitted from said at least one device.

21. The display article as claimed in claim 20, wherein the section is displaceable away from the adjacent area of the first member by bending or folding.

22-44. (canceled)
